(19) United States
(12) Patent Application Publication
(10) Pub. No.: US 2008/0056703 A1
(43) Pub. Date: Mar. 6, 2008

(54) IMAGE CAPTURE METHODS AND SYSTEMS

(75) Inventors: Jing Shun Lin, Yilan County (TW); Hong Chi Tsai, Taipei County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/845,598

(22) Filed: Aug. 27, 2007

(30) Foreign Application Priority Data
Aug. 29, 2006 (TW) TW95131708

(51) Int. Cl. G03B 13/36; G03B 9/02

(52) U.S. Cl. 396/127; 396/505

(57) ABSTRACT

Image capture methods and systems. When a shutter of a camera is pressed, a diaphragm of the camera is set to a maximum diaphragm, and an image is photographed accordingly. The diaphragm is switched to a next level diaphragm of the maximum diaphragm, and another image is photographed accordingly. The switch of the diaphragm and the photographing is repeated until the diaphragm is the minimum diaphragm.

### BACKGROUND OF THE INVENTION

1. Field of the Invention

The invention relates generally to image capture methods and systems, and, more particularly, to methods and systems that photograph images using various diaphragms.

2. Description of the Related Art

In photography, diaphragm, shutter and exposure are key factors influencing successful image capture. The diaphragm adjusts the aperture of a camera, such that the amount of light entering the camera is adjusted accordingly. In response to a specific amount of light, the shutter must be set appropriately to obtain a reasonable exposure time, thereby capturing with conventional exposure.

As diaphragm size increases, depth of field is reduced accordingly. The depth of field represents the range of object distance within which objects are in sharp focus. The depth of field follows the focus point, around thereto. As distance between an object and the focus point increases, and depth of field reduces, blurring of the object increases accordingly.

Pinhole cameras are simple cameras using a hole for exposure. Since the hole is very small, the depth of field is infinitely long. In conventional cameras, a group of lenses is used for focus. FIG. 1 illustrates focus properties of a convex lens. It is noted that a single convex lens is used in this example for explanation. Focus properties for multiple convex lenses in conventional cameras is similar thereto, and omitted herefrom. As shown in FIG. 1, parallel light reflected from point A is refracted passing the lens, and through the focal length. Light through the axial center of the lens is not refracted. The intersection point A′ of two light beams is where an object image is formed. In addition to the two light beams, all light reflected from an object intersects at point A′, as shown in FIG. 2. Film or an image sensor, such as CCD (Charge Coupled Device) or CMOS (Complementary Metal Oxide Semiconductor) is disposed where the object image is formed (Point A′).

FIG. 3 illustrates the function of depth of field. As shown in FIG. 3, the positions of image forming for objects placed at different positions are different. If the image sensor is placed at image forming point C′ corresponding to point C, only point C is clear theoretically. Since the formation of image for point B or D on the image sensor is a range, it is blurred. If dimensions of an area are less than minimum value, such as 1/2800 inch, features thereof are not distinguishable to the naked eye, appearing as a point. If a point formed on a photo is bigger than the area, the image is blurred. Therefore, if the formation of image for point B in FIG. 3 is smaller than the minimum value, point B is considered clear. The depth of field is a range within which points B and D are clear.

The size of the diaphragm determines the depth of field, thereby creating various effects on photos. However, users cannot easily realize and control the relationship between the diaphragm and the depth of field, with no solution is provided in conventional cameras correspondingly.

### BRIEF SUMMARY OF THE INVENTION

Image capture methods and systems are provided.

In an embodiment of an image capture method, when a shutter of a camera is pressed, a diaphragm of the camera is set to a first value, and a first image is photographed accordingly. The diaphragm is reset to a second value, and a second image is photographed accordingly.

An embodiment of an image capture system comprises a diaphragm, an image capture unit and processing unit. When a shutter of a camera is pressed, the processing unit sets the diaphragm to a first value, and photographs accordingly via the image capture unit to obtain a first image. The processing unit resets the diaphragm as a second value, and photographs accordingly via the image capture unit to obtain a second image

Image capture methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating focus properties of convex lens;

FIG. 2 is a schematic diagram illustrating focus properties of convex lens;

FIG. 3 is a schematic diagram illustrating the theory of depth of field;

FIG. 4 is a schematic diagram illustrating an embodiment of an image capture system;

FIG. 5 is a flowchart of an embodiment of an image capture method; and

FIG. 6 is a flowchart of an embodiment of an image capture method.

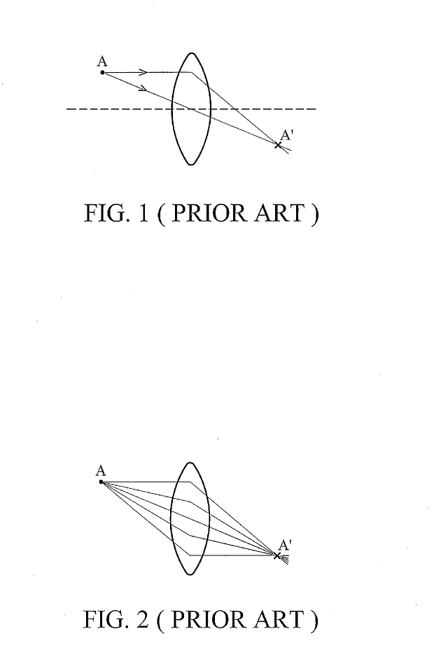

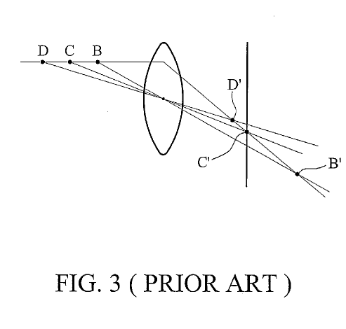

### DETAILED DESCRIPTION OF THE INVENTION

Image capture methods and systems are provided.

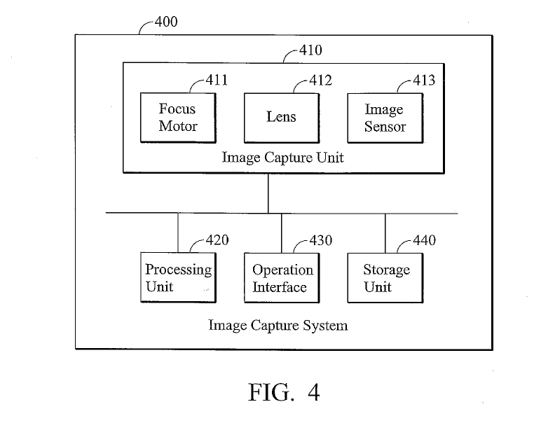

FIG. 4 illustrates an embodiment of an image capture system.

The image capture system 400 comprises an image capture unit 410, a processing unit 420, an operation interface 430 and a storage unit 440. The image capture unit 410 comprises a focus motor 411, a lens group 412 and an image sensor 413. The focus motor 411 may be a stepping motor driving the lens group 412 to execute focus. To focus, the focus motor 411 moves within a focus range. Once a step is moved, an AF (Auto Focus) window value is calculated. After the focus motor has moved the entire focus range, a curve of the AF window values is obtained. The step number for the focus motor 411 can be calculated according to the maximum AF window value in this focus curve, where the step number is the focus point corresponding to the object. It is noted that any focus manner can be applied in the invention, which is not limited thereto. The image sensor 413 may be a CCD or CMOS placed at the position where the image of object is formed, for image sensing.

The processing unit 420 controls related components of the image capture system 400. The processing unit 420 performs related processes to the images captured by the image capture unit 410. For example, the processing unit 420 can compress the images, or store the images to the storage unit 440, such as a built-in memory of the image capture system 400 or external memory card. Additionally, the processing unit 420 performs the image capture methods of the invention, the details of which are discussed later. Users can perform related settings via the operation interface 430, such as selecting a specific image for storage to storage unit 440, or for editing.

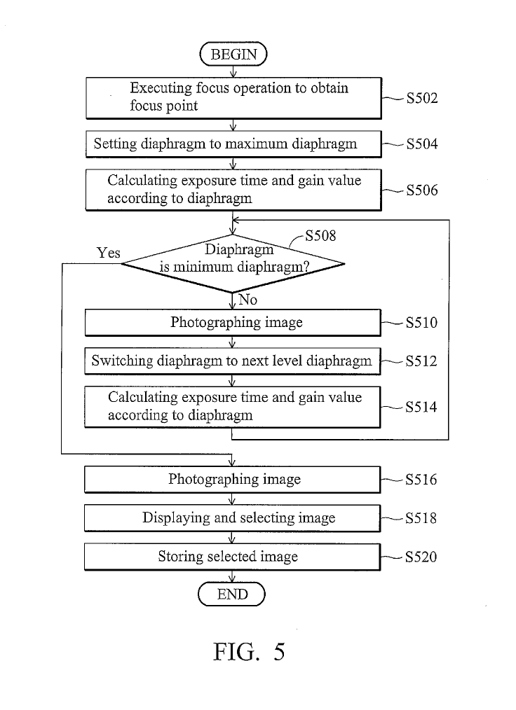

FIG. 5 shows an embodiment of an image capture method for use in a digital camera.

When the shutter of the camera is pressed, in step S502, the camera executes focus toward an object. As described, the focus motor 411 can move within a focus range. Once a step is moved, an AF window value is calculated. After the focus motor has moved the entire focus range, a curve of the AF window values is obtained. The step number for the focus motor 411 can be calculated according to the maximum AF window value in this focus curve, where the step number is the focus point corresponding to the object. Similarly, the focus manner is not limited thereto. In step S504, a diaphragm of the camera is set to a maximum diaphragm, and in step S506, related parameters required are calculated according to the diaphragm. For example, an exposure time and a gain value, such as ISO value, are calculated according to the diaphragm. In step S508, it is determined whether the diaphragm is at a minimum setting. If not (No in step S508), in step S510, an image is photographed according to the focus point, diaphragm and related parameters, such as exposure time and gain value. In step S512, the diaphragm is switched to a next (smaller) level, and in step S514, the related parameters required are re-calculated accordingly. The procedure returns to step S508.

It is understood that under a specific exposure amount, if a f-number of the diaphragm is F 2.8, the corresponding exposure time is 1/60 second, and the gain value is 100. F-number is an inverse ratio of the aperture size. F-number is the focal length divided by the diameter of the aperture. If the diaphragm is F 4 (F 4 is the next level diaphragm of F 2.8), since the diaphragm is one level less than F 2.8 halving the exposure amount from that in F 2.8, the exposure time must be extended to obtain the same exposure amount. Therefore, the corresponding exposure time is 1/30 second, and the gain value is 100. If the diaphragm is F 5.6 (F 5.6 is the next level diaphragm of F 4), since the diaphragm is one level less than F 4, having the exposure amount from half of that in F 4, the exposure time must be extended to obtain the same exposure amount. However, if the exposure time is extended to 1/15 second, camera unsteadiness becomes more likely. Therefore, the exposure time is maintained at 1/30 second, and the gain value is adjusted to 200. It is understood that the determinations of the exposure time and gain value are examples, and the disclosure is not limited thereto. For example, if the diaphragm is F 5.6, the corresponding exposure time is set to 1/15 second, and the gain value is 100 when unsteadiness is unlikely.

If so (Yes in step S508), in step S516, another image is photographed according to the focus point, diaphragm and related parameters. In step S518, the images captured under various diaphragms are displayed, and a specific image is selected therefrom via the operation interface. After the specific image is selected, in step S520, the selected image is stored. It is understood that, in some embodiments, the camera can store all images captured under various diaphragms.

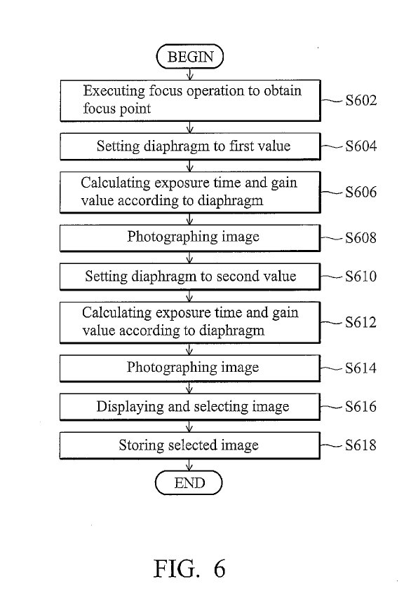

FIG. 6 shows an embodiment of an image capture method for use in a digital camera.

When the shutter of the camera is pressed, in step S602, the camera executes focus toward an object. In step S604, a diaphragm of the camera is set to a first value, and in step S606, related parameters such as exposure time and gain value are calculated according to the diaphragm. As described, the f-number is an inverse ratio of the aperture size. In some embodiments, the first value is the minimum value to which the diaphragm can be set, representing the maximum aperture. In step S608, an image is photographed according to the focus point, diaphragm and related parameters. In step S610, the diaphragm is reset to a second value, and in step S612, the related parameters are re-calculated accordingly. In some embodiments, the second value is the maximum value to which the diaphragm can be set, representing the minimum aperture. In some embodiments, the second value and the first value of the diaphragm may differ by one level from each other. In step S614, an image is photographed according to the focus point, diaphragm and related parameters. In step S616, the images captured under various diaphragms are displayed, and a specific image is selected therefrom via the operation interface. After the specific image is selected, in step S618, the selected image is stored. Similarly, in some embodiments, the camera can store all images captured under various diaphragms.

Therefore, the invention switches the diaphragm during one photographing, such that a series of images under various diaphragms is captured, where the images have different effects on the depth on field. Users can select favorite images in real time or subsequently. It is understood that the camera executes focus during photographing to obtain a specific focus point. In some embodiments, the camera can photograph several photos at a predefined range around the specific focus point using a fixed diaphragm, thereby obtaining a series of images with the same depth of field, but with different focus points.

Image capture methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image capture method for use in a camera, comprising:
pressing a shutter of the camera;
setting a diaphragm of the camera to a first value;
photographing a first image according to the diaphragm;
resetting the diaphragm to a second value; and
photographing a second image according to the diaphragm.

2. The method of claim 1 further comprising:
detecting a focus point; and
photographing the first image according to the diaphragm and the focus point.

3. The method of claim 2 wherein the detection of the focus point further comprises:
moving a focus motor within a focus range to obtain a curve of AF (Auto Focus) window values; and
obtaining the focus point from the maximum AF window value in the curve.

4. The method of claim 1 further comprising:
calculating a first exposure time according to a fixed exposure amount and the first value of the diaphragm; and
photographing the first image according to the first value of the diaphragm and the first exposure time.

5. The method of claim 4 further comprising:
calculating a second exposure time according to the fixed exposure amount and the second value of the diaphragm; and
photographing the second image according to the second value of the diaphragm and the second exposure time.

6. The method of claim 1 further comprising:
calculating a first gain value according to a fixed exposure amount and the first value of the diaphragm; and
photographing the first image according to the first value of the diaphragm and the first gain value.

7. The method of claim 6 further comprising:
calculating a second gain value according to the fixed exposure amount and the second value of the diaphragm; and
photographing the second image according to the second value of the diaphragm and the second gain value.

8. The method of claim 1 further comprising selecting one of the first and second images for storage.

9. The method of claim 1 wherein the first value is a minimum value of the diaphragm.

10. The method of claim 9 wherein the first value and the second value of the diaphragm differ by a diaphragm level, or the second value is a maximum value of the diaphragm.

11. The method of claim 9 further comprising, during the image capture of one press of the shutter, repeatedly changing the diaphragm, and photographing images accordingly until the diaphragm is the minimum diaphragm.

12. An image capture system, comprising:
a shutter;
a diaphragm;
an image capture unit; and
a processing unit, when the shutter is pressed, setting the diaphragm to a first value, photographing a first image according to the diaphragm, resetting the diaphragm to a second value, and photographing a second image according to the diaphragm.

13. The system of claim 12 wherein the processing unit detects a focus point by moving a focus motor within a focus range to obtain a curve of AF (Auto Focus) window values, obtaining the focus point from the maximum AF window value in the curve, and photographing the first image according to the diaphragm and the focus point.

14. The system of claim 12 wherein the processing unit further calculates a first exposure time according to a fixed exposure amount and the first value of the diaphragm, and photographs the first image according to the first value of the diaphragm and the first exposure time.

15. The system of claim 14 wherein the processing unit further calculates a second exposure time according to the fixed exposure amount and the second value of the diaphragm, and photographs the second image according to the second value of the diaphragm and the second exposure time.

16. The system of claim 12 wherein the processing unit further calculates a first gain value according to a fixed exposure amount and the first value of the diaphragm, and photographs the first image according to the first value of the diaphragm and the first gain value.

17. The system of claim 16 wherein the processing unit further calculates a second gain value according to the fixed exposure amount and the second value of the diaphragm, and photographs the second image according to the second value of the diaphragm and the second gain value.

18. The system of claim 12 wherein the first value is a minimum value of the diaphragm.

19. The system of claim 18 wherein the first value and the second value of the diaphragm differ by a diaphragm level, or the second value is a maximum value of the diaphragm.

20. The system of claim 18 wherein during the image capture of one press of the shutter, the processing unit further repeatedly changes the diaphragm, and photographs images accordingly until the diaphragm is the minimum diaphragm.
